(19) United States
(12) Patent Application Publication
(10) Pub. No.: US 2003/0204655 A1
(43) Pub. Date: Oct. 30, 2003

(54) Prioritizing vector generation in interrupt controllers

(76) Inventors: Mark A. Schmisseur, Phoenix, AZ (US); Timothy J. Jehl, Higley, AZ (US); John F. Tunny, Mesa, AZ (US); Marc A. Goldschmidt, Scottsdale, AZ (US)

Correspondence Address: Timothy N. Trop, TROP, PRUNER & HU, P.C., 8554 KATY FWY, STE 100, HOUSTON, TX, 77024-1841, US

(21) Appl. No.: 10/131,320

(22) Filed: Apr. 24, 2002

(51) Int. Cl. G06F 13/24

(52) U.S. Cl. 710/260; 710/264; 710/268; 710/269

(57) ABSTRACT

An interrupt controller may receive a plurality of interrupts from a variety of sources. An interrupt source register may be utilized to determine the interrupt source. A prioritizer may then determine the priority of each interrupt based on the source of the interrupt. The prioritizer then controls which interrupts are forwarded to a vector generator. The vector generator calculates a interrupt service routine vector of the highest priority interrupt for the core processor. As a result, the core processor receives only the highest priority interrupt vector. When the core processor has finished processing the highest priority interrupt, in some embodiments, the next highest priority interrupt vector is then forwarded for handling.

### BACKGROUND

This invention relates generally to computers or processor-based systems and particularly to interrupt controllers for those systems.

An embedded or input/output (I/O) processor may be utilized to service interrupts in processor-based systems. An interrupt is a request for attention to the processor. When a processor receives an interrupt, it suspends its current operation, saves the status of its work, and transfers control to a special routine known as an interrupt handler, containing the instructions for dealing with the interrupt. Interrupts may be generated by hardware devices to request service or report problems or by the processor itself in response to program errors or requests for operating system services.

A hierarchy of interrupt priorities determines which interrupt request will be handled first, when more than one interrupt requests are made. An interrupt handler is a special routine that is executed when a specific interrupt occurs. Interrupts from different sources may have different handlers to carry out the corresponding interrupt tasks.

Handling interrupts quickly is important to performance of applications running on a system. A system may have a large number of interrupt sources that must be handled in a core processor with a smaller number of interrupt inputs. As a result, a large number of interrupt sources are coalesced to a smaller number of interrupt inputs supported by the core processor.

In some processors, a limited number of interrupts are provided. Generally a higher priority interrupt is for more urgent interrupts that are handled more quickly. Thus, a variety of interrupt sources are steered to one of the interrupt inputs.

The interrupt service routine for the interrupt inputs searches through all of the possible sources of interrupts to identify which source currently needs service. With a large number of sources, this search can consume significant time and lead to lower system performance.

A consolidated source register may be provided to provide hardware support for interrupt processing. With these registers, the specific interrupt service routine can read the corresponding source register and then parse through the register bits to identify the active sources to determine the highest priority interrupt requiring service. This offloads, from the interrupt service routine, the need to read from each possible source by supplying a single register to read for this information.

However, the interrupt service routine is still responsible for searching this source register for the active source, and then looking at the interrupt service routine for that active source before the desired interrupt service routine can be executed. In a system where interrupt processing is a major component of system performance, this overhead in the interrupt service routine may negatively impact system performance.

Thus, there is a need for ways of handling interrupts in a fashion that improves system performance.

### BRIEF DESCRIPTION OF THE DRAWINGS

FIG. 1 is a schematic depiction of one embodiment of the present invention;

FIG. 2 is a depiction of an interrupt controller in accordance with one embodiment of the present invention; and

FIG. 3 is a schematic depiction of a prioritized interrupt vector generator in accordance with one embodiment of the present invention.

### DETAILED DESCRIPTION

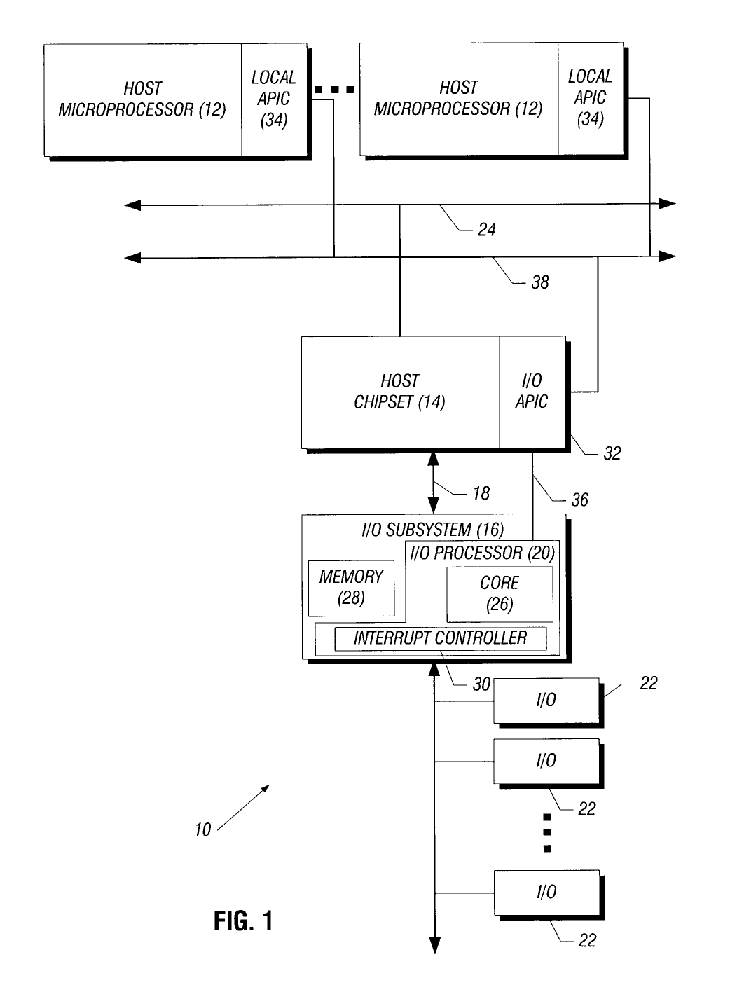

Referring to FIG. 1, a processor-based system 10 may include one or more host microprocessors 12, a host chipset 14 and an input/output (I/O) subsystem 16 in one embodiment of the present invention. A primary bus 18, that may be a peripheral component interconnect (PCI) bus, interconnects the host chipset 14 and the input/output subsystem 16. A secondary bus 20, that may also be a peripheral component interconnect bus, interconnects the I/O subsystem 16 and a set of I/O devices 22 that may be any of a variety of input/output devices including small computer system interface (SCSI) chips or asynchronous transfer mode (ATM) chips. The host chipset 14 may be coupled to a host processor 12 by a host bus 24.

With this arrangement, the host chipset 14 provides a bridge between the host bus 24 and the primary bus 18. The I/O subsystem 16 handles I/O operations that would otherwise need to be handled by the host processor 12.

The I/O subsystem 16 may include an I/O processor 20 and memory 28. The I/O processor 20 may consist of a core processor 26 and an interrupt controller 30 to facilitate I/O operations. The interrupt controller 30 receives interrupts and routes the interrupts as needed into the core processor 26 for further processing.

An I/O advanced programmable interrupt controller (APIC) 32 within the host chipset 14 and a local APIC unit 34 within each host processor 12 provide additional interrupts in one embodiment. Additional interrupt lines 36 may be coupled directly from the I/O devices 22 to the I/O APIC 32 of the host chipset 14. The I/O APIC 32 of the host chipset 14 may communicate directly with local APICs 34 and the host processors 12 over the bus 38.

With this arrangement, interrupt signals generated by the I/O devices 22 are routed indirectly to the I/O APIC 32 of the host chipset 14 through the I/O Subsystem 16. The I/O APIC 32 in turn converts the interrupts into standard interrupts for routing to the host processors 12 over the bus 38. While one exemplary embodiment for a processor-based system is shown in FIG. 1, a variety of other computer architectures are applicable to the present invention.

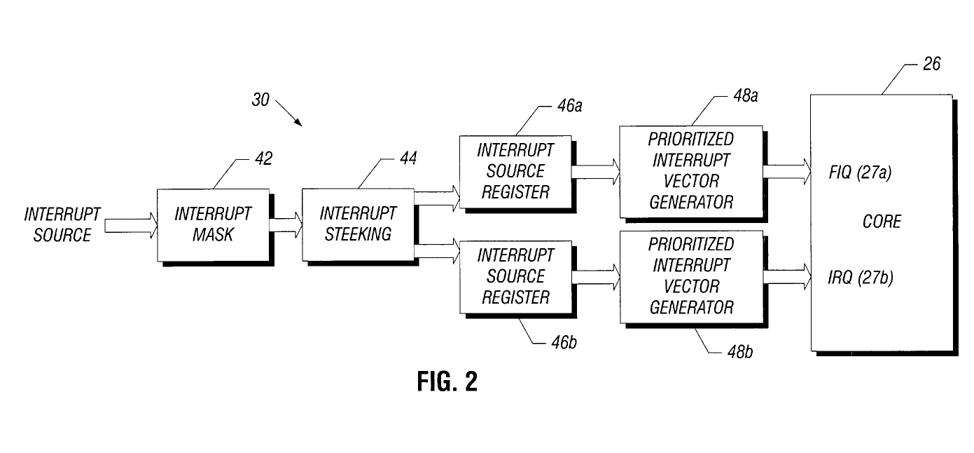

Referring to FIG. 2, a core processor may have two interrupt inputs FIQ 27a and IRQ 27b. The interrupt controller 30 consolidates all interrupts to either FIQ or IRQ. The interrupt controller 30 may forward an interrupt from an interrupt source which is unmasked. The interrupt may be masked at 42 and steered, in one embodiment of the present invention, at 44 to either a FIQ interrupt source register 46a or a IRQ interrupt source register 46b. The resulting interrupt may then be prioritized in an interrupt vector generator 48a or 48b.

Each prioritized interrupt vector generator 48a receives one or more interrupts that are currently asserted. Based on a priority assigned to each interrupt source identified by the interrupt source register 46, the generator 48 determines which interrupt to forward to the core 26 for processing. Thus, the vector generator 48a forwards the highest priority interrupt for servicing and holds any other interrupts until the higher priority interrupt is serviced.

The generator 48 can determine when to assert lower priority interrupts by determining when a higher priority interrupt, already forwarded to the core 26, is no longer asserted. In other words, when the generator 48 no longer receives information about the already forwarded interrupt, the generator 48 knows that the interrupt previously forwarded has been handled. The next highest priority interrupt can then be forwarded to the core 26 for processing, in one embodiment of the present invention.

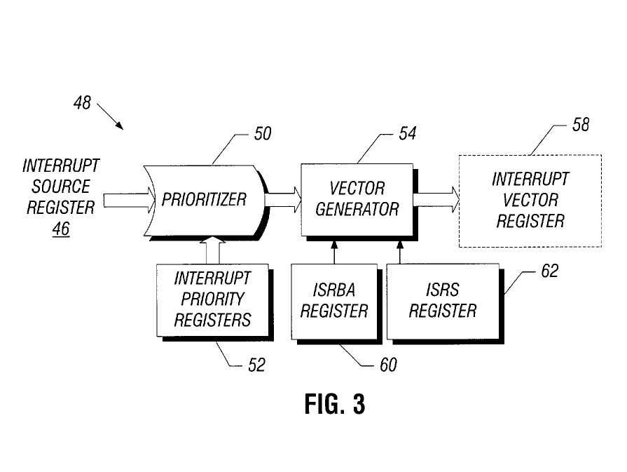

Referring to FIG. 3, one prioritized interrupt vector generator 48 may be utilized for each of the FIQ or IRQ interrupts. A prioritizer 50 is coupled to an interrupt priority register 52. The register 52 stores priorities associated with each of the possible preassigned interrupt sources. Thus, each interrupt may be given a priority based on the source that originated the interrupt. The prioritizer 50 then determines which interrupt is highest priority.

The prioritizer 50, in one embodiment, assigns one of four priority levels to each source, for example using a two bit code. If two interrupts have the same two bit code, a default resolution criteria may be used, such as selecting the interrupt with the lowest interrupt number.

The prioritizer 50 forwards only the highest priority interrupt to the vector generator 54. The vector generator 54 generates a vector address calculated from the interrupt number and values in a Interrupt Service Routine Base Address Register (ISRBAR) 60 and Interrupt Service Routine Size Register (ISRSR) 62. Using a simple equation in one embodiment where the Vector is equal to the interrupt number multiplied by the ISRSR as the offset added to the ISRBAR. The vector is then forwarded to an interrupt vector register 58. The interrupt vector register 58 may then be read by the core processor 26.

The core processor 26 services the interrupt using the appropriate interrupt service routine. Once the interrupt has been handled, it no longer appears at the prioritized vector generator 48 and therefore, the next highest priority interrupt can be passed on to the core processor 26 for servicing.

The prioritized interrupt vector generator 48 calculates a vector address using any of a variety of available protocols. In one embodiment, the vector generator 54 takes a base register and adds to it the product of the interrupt number and size to generate a vector address.

As a result of the ability to prioritize the interrupts based on originating source, the interrupt service routine does not have to search the source register for the active source to determine which interrupts to handle first in some embodiments. Once the interrupt service routine receives the vector address, it knows it only has to handle the single highest priority, asserted interrupt. As a result, the interrupt servicing overhead for processors, such as I/O processors, may be reduced. Reducing the interrupt servicing overhead allows processors to deliver higher application performance in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a plurality of interrupts;
determining the source of each interrupt;
determining the priority of the interrupt based on its source; and
forwarding the vector for the highest priority interrupt for interrupt handling.

2. The method of claim 1 including holding interrupts having a lower priority while forwarding the vector for the highest priority interrupt.

3. The method of claim 2 including waiting until the highest priority interrupt has been handled before forwarding the vector for the next highest priority interrupt for handling.

4. The method of claim 1 including assigning one of a predetermined number of priority levels to an interrupt based on its source.

5. The method of claim 4 including assigning one of four priority levels based on the source of the interrupt.

6. The method of claim 1 including handling interrupts according to two different interrupt types.

7. The method of claim 6 including handling FIQ interrupts differently than IRQ interrupts.

8. The method of claim 7 including assigning separate priority levels to FIQ interrupts and IRQ interrupts.

9. The method of claim 1 including calculating a vector address for the highest priority interrupt.

10. The method of claim 9 including assigning a interrupt service routine base address register and interrupt service routine size register for calculating a vector address for the highest priority interrupt.

11. The method of claim 10 including calculating a vector address for the highest priority interrupt based on the interrupt number multiplied by the value of the interrupt service routine size register added to the value of the interrupt service routine base address register.

12. The method of claim 1 including determining when an interrupt is no longer asserted and in response to an interrupt being no longer asserted, forwarding the vector for the next highest priority interrupt for interrupt handling.

13. An article comprising a medium storing instructions that, if executed, enable a processor-based system to perform the steps of:
receiving a plurality of interrupts;
determining the source of each interrupt;
determining the priority of the interrupt based on its source; and
forwarding the vector for the highest priority interrupt for interrupt handling.

14. The article of claim 13 further storing instructions that enable the processor-based system to perform the step of holding interrupts having a lower priority while forwarding the vector for the highest priority interrupt.

15. The article of claim 14 further storing instructions that enable the processor-based system to perform the step of waiting until the highest priority interrupt has been handled before forwarding the vector for the next highest priority interrupt for handling.

16. The article of claim 13 further storing instructions that enable the processor-based system to perform the step of assigning one of a predetermined number of priority levels to an interrupt based on its source.

17. The article of claim 16 further storing instructions that enable the processor-based system to perform the step of assigning one of four priority levels based on the source of the interrupt.

18. The article of claim 13 further storing instructions that enable the processor-based system to perform the step of handling interrupts according to two different interrupt types.

19. The article of claim 18 further storing instructions that enable the processor-based system to handle FIQ and IRQ interrupts differently.

20. The article of claim 19 further storing instructions that enable the processor-based system to perform the step of assigning separate priority levels to FIQ interrupts and IRQ interrupts.

21. The article of claim 13 further storing instructions that enable the processor-based system to perform the step of calculating a vector address for the highest priority interrupt.

22. The article of claim 21 further storing instructions that enable the processor-based system to perform the step of assigning a value to a interrupt service routine base address register and interrupt service routine size register for calculating a vector address for the highest priority interrupt.

23. The article of claim 22 further storing instructions that enable the processor-based system to perform the step of calculating a vector address for the highest priority interrupt based on the interrupt number multiplied by the value of the interrupt service routine size register added to the value of the interrupt service routine base address register.

24. The article of claim 13 further storing instructions that enable the processor-based system to perform the steps of determining when an interrupt is no longer asserted and in response to an interrupt no longer being asserted, forwarding the vector for the next highest priority interrupt for interrupt handling.

25. An interrupt controller comprising:
an interrupt source register to determine the source of an interrupt;
a prioritizer to determine the priority of the interrupt based on its source; and
a vector generator to forward the vector for the highest priority interrupt for interrupt handling.

26. The interrupt controller of claim 25 wherein said vector generator calculates a vector for the highest priority interrupt.

27. The interrupt controller of claim 25 wherein said prioritizer holds interrupts other than the highest priority interrupt.

28. The interrupt controller of claim 27 wherein said prioritizer holds the lower priority interrupts until the highest priority interrupt has been handled.

29. The interrupt controller of claim 25 including a separate prioritizer for FIQ interrupts and for IRQ interrupts.

30. A processor-based system comprising:
a processor; and
an interrupt controller coupled to said processor, said interrupt controller having an interrupt source register to determine the source of an interrupt, a prioritizer to determine the priority of the interrupt based on its source and a vector generator to forward the vector for the highest priority interrupt for interrupt handling by said processor.

31. The system of claim 30 wherein said system is an input/output processor.

32. The system of claim 30 wherein said interrupt controller holds interrupts other than the highest priority interrupt.

33. The system of claim 32 wherein said interrupt controller detects when the highest priority interrupt has been handled by the processor.

34. The system of claim 33 wherein said prioritizer forwards the next highest priority interrupt to the processor after the highest priority interrupt has been handled.
